(19) United States
(12) Patent Application Publication
(10) Pub. No.: US 2009/0200767 A1
(43) Pub. Date: Aug. 13, 2009

(54) APPARATUS FOR MOUNTING STABILIZER BAR FOR VEHICLES

(76) Inventors: Man-Seung Lim, Gyeonggi-Do (KR); Jin-Young Kim, Gyeonggi-Do (KR); Yung-Jin Kang, Incheon (KR)

Correspondence Address: ARENT FOX LLP, 1050 CONNECTICUT AVENUE, N.W., SUITE 400, WASHINGTON, DC, 20036, US

(21) Appl. No.: 12/306,400

(22) PCT Filed: Jan. 8, 2007
(86) PCT No.: PCT/KR07/00094

§ 371 Date: Dec. 23, 2008

(30) Foreign Application Priority Data
Jun. 27, 2006 (KR) 10-2006-0057962

(51) Int. Cl. B60G 21/055

(52) U.S. Cl. 280/124.152

(57) ABSTRACT

An apparatus for mounting a stabilizer bar to a vehicle body frame is disclosed. The stabilizer bar mounting apparatus (1) of the present invention includes a rubber bushing (10), metal plates (30) and a mounting bracket (20). The rubber bushing (10) includes a main body (100), which has a holding hole (100a) for insertion of the stabilizer bar (2), and has a slit (100b) extending from an upper surface thereof to the holding hole (100a). Elastic holes (101) are formed in each of the opposite ends of the main body (100) to reduce stiffness of the main body in a rotational direction. The metal plates (30) are inserted into the main body of the rubber bushing (10) to prevent the rubber bushing from being deformed. The mounting bracket (20) includes a bushing receiving part (200) and a pair of mounting plates (201), which are provided on respective opposite edges of the bushing receiving part, so that the mounting bracket receives and fastens the rubber bushing to the vehicle body frame.

### TECHNICAL FIELD

The present invention relates, in general, to apparatuses for mounting stabilizer bars for vehicles and, more particularly, to an apparatus for mounting a stabilizer bar for vehicles in which a rubber bushing has reduced stiffness with respect to a rotational direction, thus preventing slippage between the stabilizer bar and the rubber bushing, and the rubber bushing has enhanced internal stiffness, so that the rubber bushing is prevented from being deformed even after it is used for a long period, thus preventing a gap from occurring between the stabilizer bar and the rubber bushing, and preventing the rubber bushing from being deformed due to compressing force when the rubber bushing is press-mounted to the vehicle body frame, thereby enhancing the mounting force.

### BACKGROUND ART

As well known to those skilled in the art, a stabilizer bar is a device used in a vehicle to acquire anti-roll stiffness of the vehicle body.

FIG. 1 is a view showing the mounting of a typical stabilizer bar. As shown in FIG. 1, the stabilizer bar 2 is mounted to a vehicle body frame (not shown) using a pair of stabilizer bar mounting apparatuses 1, each of which has a rubber bushing 10 and a mounting bracket 20 that receives the rubber bushing 10 and fastens it to the vehicle body frame.

Hereinafter, the conventional stabilizer bar mounting apparatus 1 will be explained in detail with reference to FIG. 2. FIG. 2 is an exploded perspective view of the conventional stabilizer bar mounting apparatus 1. As shown in FIG. 2, the conventional stabilizer bar mounting apparatus 1 includes a rubber bushing 10 and a mounting bracket 20. The rubber bushing 10 includes a main body 100, which has a holding hole 100a formed at a central portion therethrough, so that the stabilizer bar 2 is received in the holding hole 100a, and has a slit 100b, which is formed in the main body 100 and extends from a position of the sidewall of the holding hole 100a to the outer surface of the main body 100 at an incline. The rubber bushing 10 further includes stop protrusions 102, which are provided on the respective opposite ends of the circumferential outer surface of the main body 100. The mounting bracket 20 includes a bushing receiving part 200, which has in opposite ends thereof stop grooves 200a engaging with the respective stop protrusions 102 of the rubber bushing 10. The mounting bracket 20 further includes a pair of mounting plates 201, which are provided on the respective opposite edges of the bushing receiving part 200. Thus, the mounting bracket 20 receives the rubber bushing 10 in the circumferential inner surface thereof and fastens it to the vehicle body frame.

However, in the conventional stabilizer bar mounting apparatus 1 having the above-mentioned construction, because the rubber bushing 10 has a relatively high stiffness with respect to a rotational direction (A), the rotational resistance of the stabilizer bar 2 is increased, so that, when relatively strong torsion is applied to the stabilizer bar 2, the stabilizer bar 2 is not integrally rotated along with the rubber bushing 10 but is rotated in the rotational direction (A) with respect to the rubber bushing 10, that is, slippage occurs between the stabilizer bar 2 and the rubber bushing 10. At this time, noise is generated by friction between the stabilizer bar 2 and the rubber bushing 10.

Furthermore, the rubber bushing 10 is readily worn by the frictional heat. When it is used for a long period, the rubber bushing 10 is deformed by force that is transmitted from the stabilizer bar 2 in the rotational direction (A). Thereby, a gap occurs between the holding hole 100a of the rubber bushing 10 and the circumferential outer surface of the stabilizer bar 2. In the case where foreign substances or dust are inserted into the gap therebetween, the outer surface of the stabilizer bar 2 is easily worn, so that the durability thereof is reduced. As a result, the expected life span of the stabilizer bar 2 is markedly reduced.

### DISCLOSURE OF INVENTION

### Technical Problem

Accordingly, the present invention has been made keeping in mind the above problems occurring in the prior art, and an object of the present invention is to provide an apparatus for mounting a stabilizer bar for vehicles in which the rotational stiffness of a rubber bushing is reduced so that the rotational resistance of the stabilizer bar is reduced, thus preventing slippage between the stabilizer bar and the rubber bushing.

Another object of the present invention is to provide an apparatus for mounting a stabilizer bar for vehicles which increases the internal stiffness of the rubber bushing, so that the rubber bushing is prevented from being deformed even after being used for a long period, thus preventing a gap from occurring between the stabilizer bar and the rubber bushing, and preventing the rubber bushing from being deformed by the internal compression force of a mounting bracket, thereby enhancing the mounting ability thereof.

### Technical Solution

In order to accomplish the above objects, the present invention provides an apparatus for mounting a stabilizer bar to a vehicle body frame, comprising: a rubber bushing, including a main body having a holding hole formed at a central portion through opposite ends of the main body for insertion of the stabilizer bar into the holding hole, and a slit extending from an upper surface thereof to an upper surface of a sidewall of the holding hole such that the stabilizer bar is inserted into the holding hole, a plurality of elastic holes formed in each of the opposite ends of the main body to reduce stiffness of the main body in a rotational direction thereof, thus reducing rotational resistance of the stabilizer bar, and a stop protrusion provided on a circumferential outer surface of the main body; a plurality of metal plates inserted into the main body of the rubber bushing to form a shape such that elastic holes are sectioned into first spaces and second spaces by the metal plates, thus preventing the rubber bushing from being deformed; and a mounting bracket, comprising: a bushing receiving part having a stop groove engaging with the stop protrusion of the rubber bushing; and a pair of mounting plates provided on respective opposite edges of the bushing receiving part, the mounting bracket receiving the rubber bushing in a circumferential inner surface thereof and fastening the rubber bushing to the vehicle body frame.

### ADVANTAGEOUS EFFECTS

The present invention provides an apparatus for mounting a stabilizer bar for vehicles, which has improved ability to support the stabilizer bar, thus preventing the stabilizer bar from being pushed and leaning in radial direction, and which reduces the stiffness of a rubber bushing with respect to the rotational direction, so that slippage between the stabilizer bar and the rubber bushing is prevented from being caused, thus preventing noise from being generated by friction, thereby keeping the vehicle interior quiet when the vehicle travels. Furthermore, because the rubber bushing is prevented from being worn by frictional heat, the durability of the rubber bushing can be enhanced. Moreover, the present invention enhances the internal stiffness of the rubber bushing, so that the rubber bushing is prevented from being deformed in the rotational direction of the stabilizer bar even after it is used for a long period. Therefore, a gap is prevented from occurring between the stabilizer bar and the rubber bushing, thus preventing foreign substances, which cause abrasion of the circumferential outer surface of the stabilizer bar, from entering between the stabilizer bar and the rubber bushing. Hence, the expected life span of the stabilizer bar can be markedly extended.

As well, the rubber bushing is prevented from being deformed by compressing force when the rubber bushing is press-mounted to the vehicle body frame, thus enhancing the mounting force.

### BRIEF DESCRIPTION OF THE DRAWINGS

FIG. 1 is a view showing the mounting of a typical stabilizer bar;

FIG. 2 is an exploded perspective view of a conventional apparatus for mounting a stabilizer bar for vehicles;

FIG. 3 is a perspective view of an apparatus for mounting a stabilizer bar for vehicles, according to an embodiment of the present invention;

FIG. 4 is a plan sectional view of the stabilizer bar mounting apparatus according to the embodiment of the present invention;

FIG. 5 is a picture showing a noise tester for stabilizer bar mounting apparatuses for vehicles;

FIG. 6 is a picture showing the stabilizer bar mounting apparatus set in the noise tester of FIG. 5;

FIG. 7 is a picture showing the stabilizer bar set in a stabilizer bar durability tester using the stabilizer bar mounting apparatuses;

FIG. 8 is pictures comparing the occurrence of gaps in the mounting apparatus of the present invention and in the conventional mounting apparatus after the durability test has been conducted;

FIG. 9 is a picture showing a process of testing the axial supporting force of the mounting apparatus that supports the stabilizer bar in an axial direction;

FIG. 10 is a graph showing the results of the test of FIG. 9;

FIG. 11 is a picture showing a process of testing the stiffness of the mounting apparatus against force applied in a transverse direction;

FIG. 12 is a graph showing results of the test of FIG. 11;

FIG. 13 is a picture showing a process of testing the stiffness of the mounting apparatus against force applied in a predetermined direction; and

FIG. 14 is a graph showing results of the test of FIG. 13.

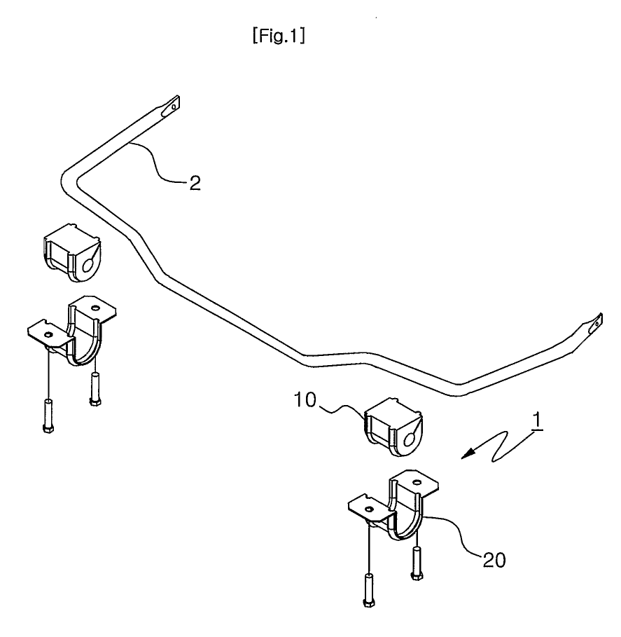

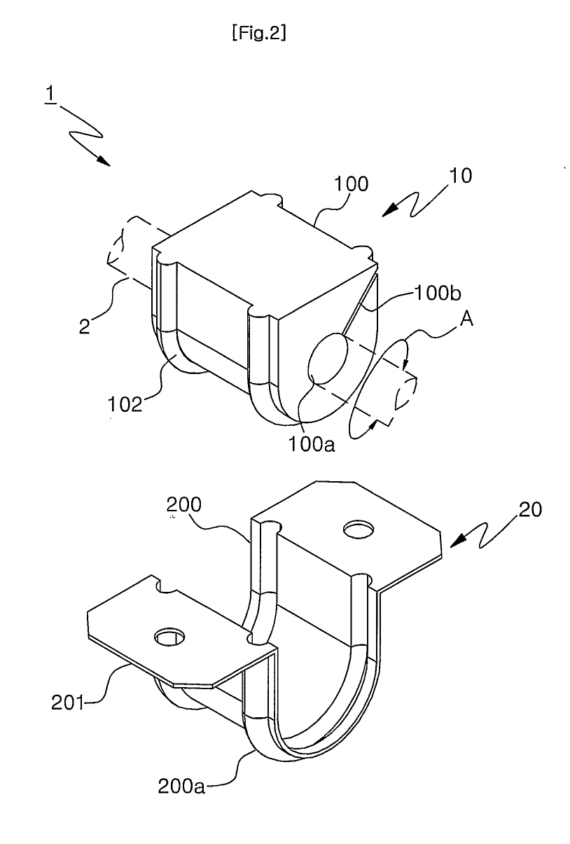

### BEST MODE FOR CARRYING OUT THE INVENTION

Hereinafter, the present invention will be described in detail with reference to the attached drawings. For convenience of description, reference should now be made to the drawings, in which the same reference numerals are used throughout the different drawings to designate the same components as those of the conventional apparatus for mounting a stabilizer bar for vehicles.

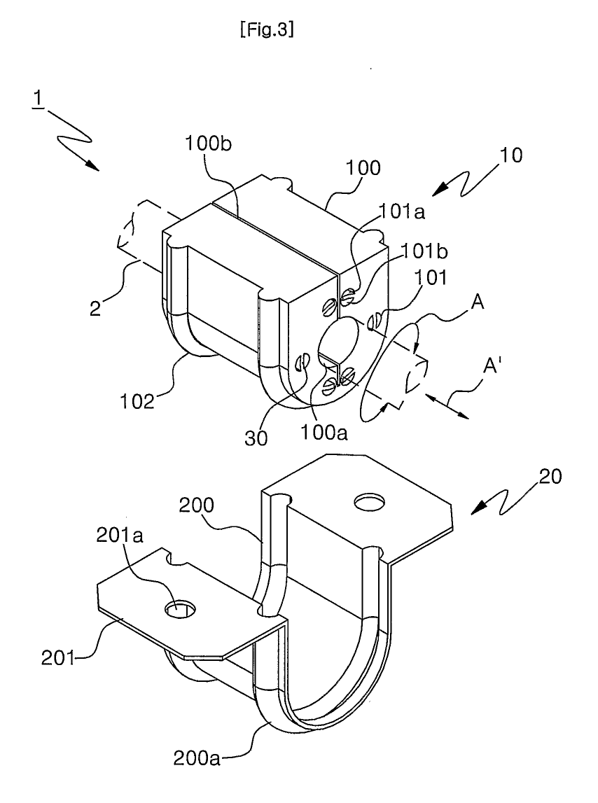

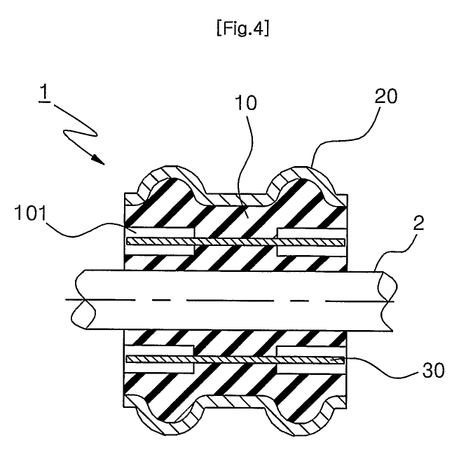

FIG. 3 is a perspective view of an apparatus for mounting a stabilizer bar for vehicles, according to an embodiment of the present invention. FIG. 4 is a plan sectional view of the stabilizer bar mounting apparatus. As shown in FIGS. 3 and 4, the stabilizer bar mounting apparatus 1 according to the embodiment of the present invention includes a rubber bushing 10, a plurality of metal plates 30 and a mounting bracket 20. The metal plates 30 are inserted into the rubber bushing 10. The rubber bushing 10, in which the metal plates 30 are inserted, is fitted over a stabilizer bar 2. The rubber bushing 10, into which the metal plates 30 are inserted, and which is fitted over the stabilizer bar 2, is supported by the mounting bracket 20, which is fastened to a vehicle body frame (not shown) such that the rubber bushing 10 is pressure-mounted to the vehicle body frame.

The rubber bushing 10 includes a main body 100, elastic holes 101 and stop protrusions 102. The main body 100 has a holding hole 100a, which is formed at a central portion through the opposite ends of the main body 100 so that the stabilizer bar 2 is received in the holding hole 100a, and a slit 100b, which is formed by cutting the main body 100 from the upper surface thereof to the upper surface of the sidewall of the holding hole 100b such that the stabilizer bar 2 can be easily inserted in the holding hole 100a using the slit 100b. Here, the holding hole 100a has a diameter smaller than the diameter of the stabilizer bar 2 so that the rubber bushing 10 is force-fitted over the stabilizer bar 2, thereby the ability of the rubber bushing 2 to support the stabilizer bar 2 is increased. Preferably, as required, the slit 100b further extends from the lower surface of the sidewall of the holding hole 100a to a predetermined depth such that, when the rubber bushing 10 is force-fitted over the stabilizer bar 2, opposite parts of the rubber bushing 10 based on the slit 100b can be easily separated from each other.

Meanwhile, several elastic holes 101 are formed in each of the opposite ends of the main body 100. Here, it is preferable that these elastic holes 101 be formed in each of the opposite ends of the main body 100 at predetermined positions arranged to form a circle. Thanks to the elastic holes 101 formed in the opposite ends of the main body 100, the stiffness of the main body 100 with respect to a direction (A) in which the stabilizer bar 2 is rotated is markedly reduced so that the rotational resistance of the stabilizer bar 2 is reduced, thus preventing slippage between the stabilizer bar 2 and the rubber bushing 10, thereby preventing noise from being generated by friction, and preventing the rubber bushing 10 from wearing.

Furthermore, the stop protrusions 102 are provided on the respective opposite ends of the circumferential outer surface of the main body 100, so that the rubber bushing 10 is coupled to the mounting bracket 20 in a concavo-convex coupling manner, thus preventing the rubber bushing 10 from moving in an axial direction (A′) with respect to the stabilizer bar 2.

The metal plates 30 are inserted into the main body 100 of the rubber bushing 10 such that the elastic holes 101 are sectioned into first spaces 101a and second spaces 101b by the metal plates 30. It is preferable that each metal plate 30 have a ‘C’ shape such that the metal plates 30 are inserted into the main body 100 at positions that surround the holding hole 100a in a cylindrical arrangement. Thanks to the metal plates 30 inserted into the main body 100 of the rubber bushing 10, the internal stiffness of the main body of the rubber bushing 10 is increased, thus preventing the rubber bushing 10 from being deformed in the direction (A) in which the stabilizer bar 2 is rotated, and preventing the rubber bushing 10 from being deformed by compressing force of the mounting bracket 20 when the rubber bushing 10 is pressure-mounted to the vehicle body frame, thereby enhancing the mounting force.

The mounting bracket 20 includes a bushing receiving part 200, which has in opposite ends thereof stop grooves 200a, into which the respective stop protrusions 102 of the rubber bushing 10 are inserted, and a pair of mounting plates 201, which are provided on respective opposite edges of the bushing receiving part 200. A mounting hole 201a is formed at the central position through each mounting plate 201. Thus, the mounting bracket 20 receives the rubber bushing 10 in the circumferential inner surface thereof and fastens it to the vehicle body frame.

The operation and effect of the apparatus 1 for mounting the stabilizer bar for vehicles according to the embodiment of the present invention will be described herein below with reference to FIGS. 3 and 4.

As shown in FIGS. 3 and 4, in the stabilizer bar mounting apparatus 1 of the present invention, because the diameter of the holding hole 100a of the main body 100 of the rubber bushing 10, into which the stabilizer bar 2 is inserted, is less than the diameter of the stabilizer bar 2, when the rubber bushing 10 is mounted to the vehicle body frame (not shown) using the mounting bracket 20, the rubber bushing 10 compresses the rubber bushing 10, thus enhancing the ability to support the stabilizer bar 2, thereby preventing the stabilizer bar 2 from slipping and leaning in one direction.

Furthermore, the several elastic holes 101 reduce the stiffness of the main body 100 of the rubber bushing 10 in the rotational direction (A), thus markedly reducing the rotational resistance of the stabilizer bar 2. Thereby, the stabilizer bar 2 is prevented from slipping with respect to the rubber bushing 10 in the rotational direction (A), thus preventing noise from being generated by friction, and preventing the rubber bushing 10 from wearing. As a result, the durability of the rubber bushing 10 can be enhanced, and the vehicle interior can be maintained quiet when the vehicle travels.

In addition, the metal plates 30 increase the internal stiffness of the main body 100 of the rubber bushing 10, thus preventing the rubber bushing 10 from being deformed by force applied in the direction (A) in which the stabilizer bar 2 is rotated, thereby preventing a gap from occurring between the circumferential outer surface of the stabilizer bar 2 and the holding hole 100a of the main body 100 of the rubber bushing 10. As such, a gap is prevented from occurring between the circumferential outer surface of the stabilizer bar 2 and the holding hole 100a of the main body 100 of the rubber bushing 10, and foreign substances are prevented from entering the space between the circumferential outer surface of the stabilizer bar 2 and the holding hole 100a of the main body 100 of the rubber bushing 10. Thus, the circumferential outer surface of the stabilizer bar 2 is prevented from being worn by the foreign substances.

Furthermore, because the internal stiffness of the metal plates 30 of the main body 100 of the rubber bushing 10 is increased by the metal plates 30, when the rubber bushing 10 is pressure-mounted to the vehicle body frame using the mounting bracket 20, the rubber bushing 10 is prevented from being deformed by the compressing force of the mounting bracket 20, so that the mounting ability thereof is enhanced.

As described above, the stabilizer bar mounting apparatus 1 of the present invention has improved ability to support the stabilizer bar 2, thus preventing the stabilizer bar 2 from being pushed and leaning in one direction. Furthermore, the present invention reduces the stiffness of the rubber bushing 10 in the rotational direction (A), so that slippage between the stabilizer bar 2 and the rubber bushing 10 is not caused, thus preventing noise from being generated by friction, thereby keeping the vehicle interior quiet when the vehicle travels. In addition, because the rubber bushing 10 is prevented from being worn by frictional heat, the durability of the rubber bushing 10 can be enhanced. Moreover, the present invention enhances the internal stiffness of the rubber bushing 10, so that the rubber bushing 10 is prevented from being deformed in the rotational direction (A) of the stabilizer bar 2 even after it is used for a long period.

Therefore, a gap is prevented from occurring between the stabilizer bar 2 and the rubber bushing 10, thus preventing foreign substances, which causes abrasion of the circumferential outer surface of the stabilizer bar 2, from entering between the stabilizer bar 2 and the rubber bushing 10. Hence, the expected life span of the stabilizer bar 2 can be markedly extended. As well, the rubber bushing 10 is prevented from being deformed by the compressing force when the rubber bushing 10 is press-mounted to the vehicle body frame, thus enhancing the mounting force.

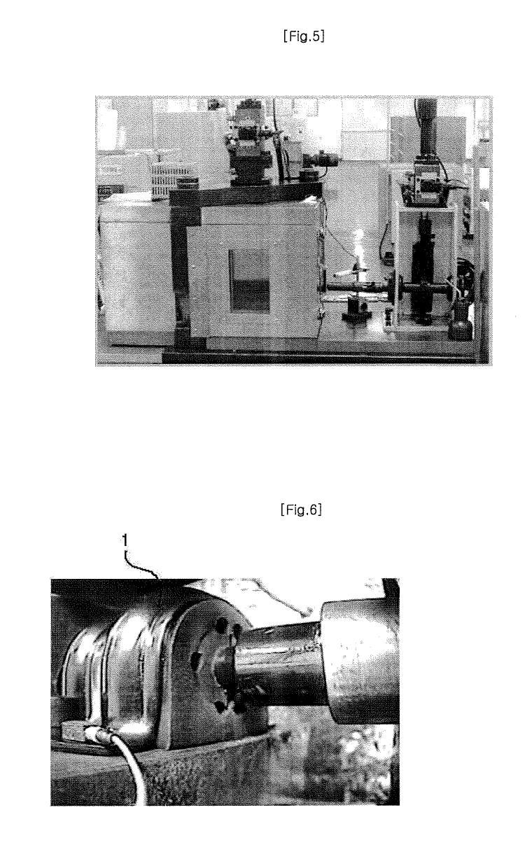

Hereinafter, the results of noise tests of the mounting apparatus 1 of the present invention and the conventional mounting apparatus will be compared with reference to FIGS. 5 and 6 and Table. 1.

FIG. 5 is a picture showing a side of a noise tester for stabilizer bar mounting apparatuses for vehicles. FIG. 6 is a picture showing the stabilizer bar mounting apparatus set in the noise tester of FIG. 5. As shown in FIGS. 5 and 6, the mounting apparatus 1 of the present invention and the conventional mounting apparatus are set in the noise testers, and the operation, in which the stabilizer bar was twisted at a torsion angle of ±20°, was repeated one million times under conditions of a sub-zero temperature, for example, 15° C. below zero, at which the generation of noise by the stabilizer bar is typically greatest. During this process, the mounting apparatuses were subjected to physical shocks for one hour at the points shown in Table. 1, and the occurrence of noise was observed.

TABLE 1

| | 0 | 50 thousand | 100 thousand | 300 thousand | 700 thousand | 1 million |
|---|---|---|---|---|---|---|
| classification | repetitions | repetitions | repetitions | repetitions | repetitions | repetitions |
| Typical | No noise | No noise | No noise | No noise | Noise | Noise |
| mounting apparatus | | | | | | |
| Mounting apparatus | No noise | No noise | No noise | No noise | No noise | No noise |
| of the present | | | | | | |
| invention | | | | | | |

As shown in the above Table. 1, in the case of the conventional mounting apparatus, noise occurred after 700 thousands repetitions, but, in the case of the mounting apparatus of the present invention, no noise occurred even after one million repetitions. Therefore, it is to be appreciated that the mounting apparatus of the present invention has very superior noise prevention ability compared to the conventional mounting apparatus.

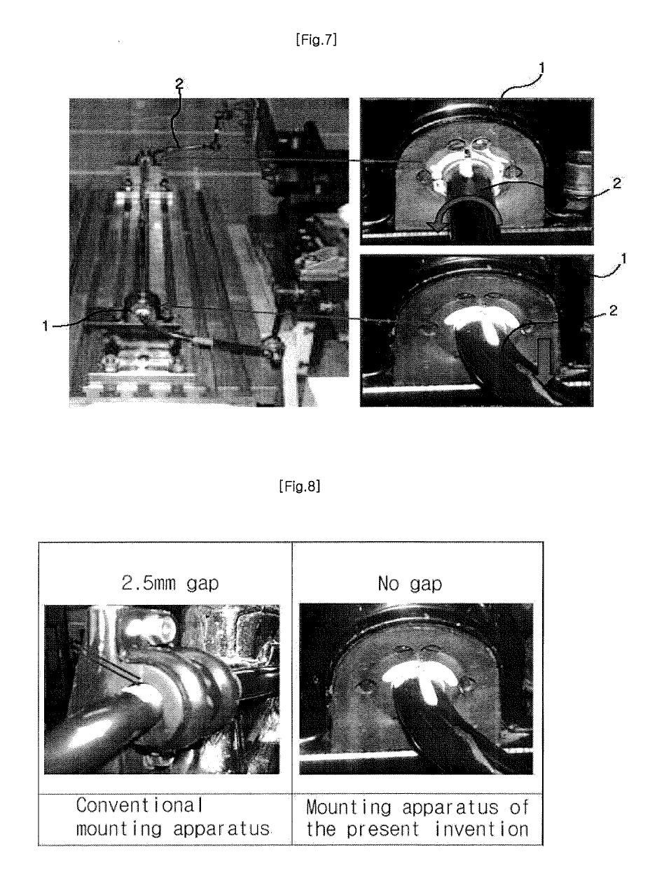

Meanwhile, the results of tests for comparing the durability of the mounting apparatus of the present invention with that of the conventional mounting apparatus will be explained with reference to FIGS. 7 and 8 and Table. 2.

FIG. 7 is a picture showing the stabilizer bar set in a stabilizer bar durability tester using the mounting apparatuses. As shown in FIG. 7, after the stabilizer bar 2 was set in the stabilizer bar durability tester using the mounting apparatuses 1, a test, in which the opposite ends of the stabilizer bar 2 are alternately moved upwards and downwards within a range of ±42 mm at a speed of 3 Hz, was conducted. The results of the test are described in the following Table. 2.

TABLE 2

| | Axial shift of stabilizer bar | | |
|---|---|---|---|
| | 50 thousand | 300 thousand | 1 million |
| classification | repetitions | repetitions | repetitions |
| Conventional | 5 mm shift | 10 mm shift | |
| mounting apparatus | | | |
| Mounting apparatus | No shift | No shift | No shift |
| of the present | | | |
| invention | | | |

As shown in Table. 2, in the case of the conventional mounting apparatus, when the operation, in which the opposite ends of the stabilizer bar are alternately moved upwards and downwards within a range of ±42 mm at a speed of 3 Hz, was repeated 50 thousand times, the stabilizer bar was shifted by 5 mm in the axial direction. When the operation was repeated 300 thousand times, the stabilizer bar was shifted by 10 mm in the axial direction. However, in the present invention, even after the operation was repeated one million times, the stabilizer bar was not shifted in the axial direction. Furthermore, FIG. 8 is pictures comparing the occurrence of gaps in the mounting apparatus of the present invention and in the conventional mounting apparatus after the durability test has been conducted. As shown in FIG. 8, after the operation, in which the opposite ends of the stabilizer bar were alternately moved upwards and downwards within a range of ±42 mm at a speed of 3 Hz, was repeated one million repetitions, the mounting apparatus was observed. As shown in FIG. 8A, in the conventional mounting apparatus, a gap of 2.5 mm occurred between the stabilizer bar and the mounting apparatus. However, as shown in FIG. 8B, in the present invention, no gap occurred between the stabilizer bar and the mounting apparatus.

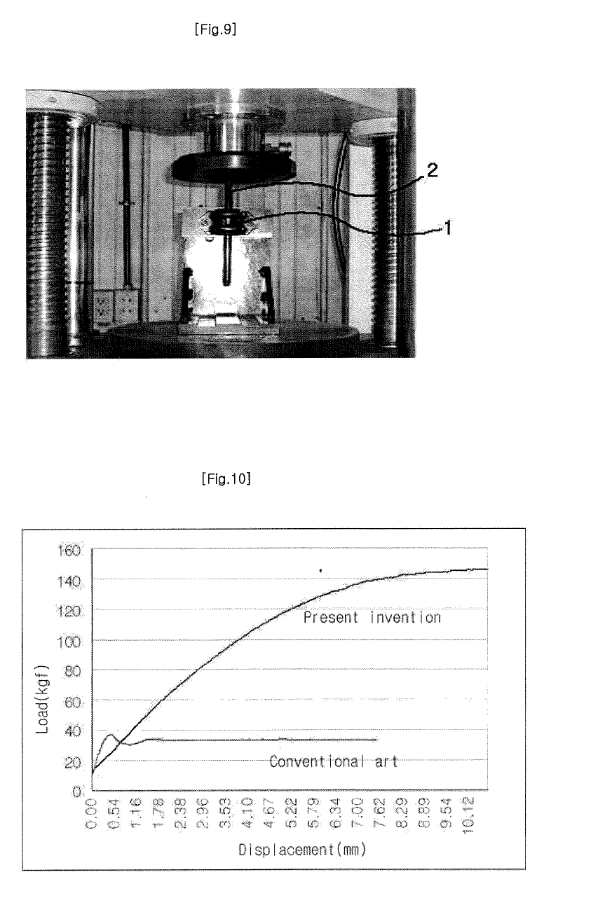

The results of tests for comparing the axial supporting forces of the mounting apparatus of the present invention and the conventional mounting apparatus will be explained with reference to FIGS. 9 and 10.

FIG. 9 is a picture showing a process of testing the axial supporting force of the mounting apparatus with respect to the stabilizer bar. FIG. 10 is a graph showing the results of the test of FIG. 9. As shown in FIG. 9, the test, in which a load is applied to the stabilizer bar 2 in an axial direction at a speed of 10 mm/min to find the axial supporting force of the mounting apparatus 1 with respect to the stabilizer bar 2, was conducted in a 20 ton class UTM (universal testing machine) using a separate jig that supported the mounting apparatus 1 such that the load could be axially applied to the stabilizer bar 2. The results of tests on the mounting apparatus of the present invention and on the conventional mounting apparatus are compared in the graph of FIG. 10. As shown in FIG. 10, the axial supporting force of the conventional mounting apparatus was approximately 36.9 kgf, and the axial supporting force of the mounting apparatus of the present invention was approximately 145.8 kgf. Therefore, even in the case of the axial support force of the mounting apparatus with respect to the stabilizer bar, it is to be appreciated that the mounting apparatus of the present invention is markedly superior compared to the conventional mounting apparatus.

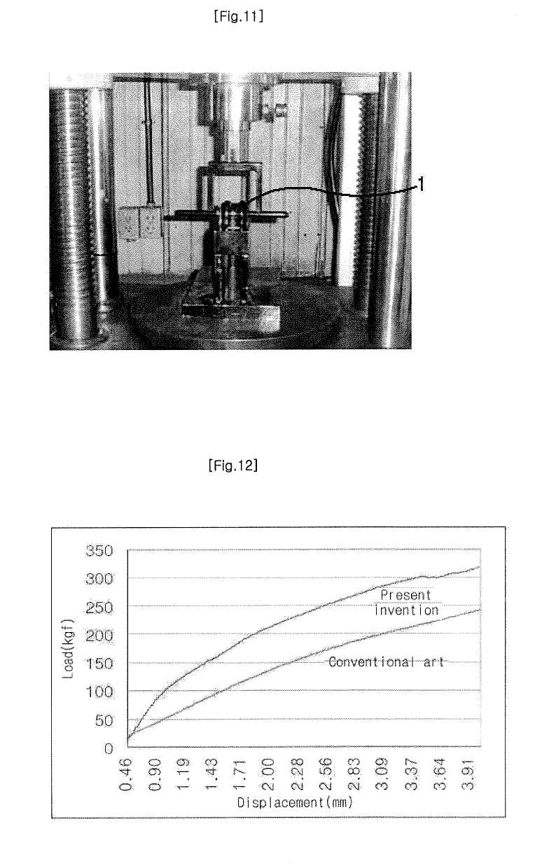

The results of a test for comparing the stiffness of the mounting apparatus of the present invention with that of the conventional mounting apparatus will be described with reference to FIGS. 11 through 14.

FIG. 11 is a picture showing a process of testing the stiffness of the mounting apparatus against transverse force. FIG. 12 is a graph showing the results of the test of FIG. 11. As shown in FIG. 11, the test, in which a load is applied to the stabilizer bar 2 in a transverse direction at a speed of 10 mm/min, was conducted in a 20 ton class UTM using a separate jig that supported the mounting apparatus 1 such that the load could be applied to the stabilizer bar 2 in a transverse direction. The results of the tests of the mounting apparatus of the present invention and the conventional mounting apparatus are compared in the graph of FIG. 12. As appreciated in the graph of FIG. 12, the mounting apparatus of the present invention required force greater than that of the conventional mounting apparatus to achieve the same displacement. Therefore, it is to be appreciated that the stiffness of the mounting apparatus of the present invention is greater than that of the conventional mounting apparatus.

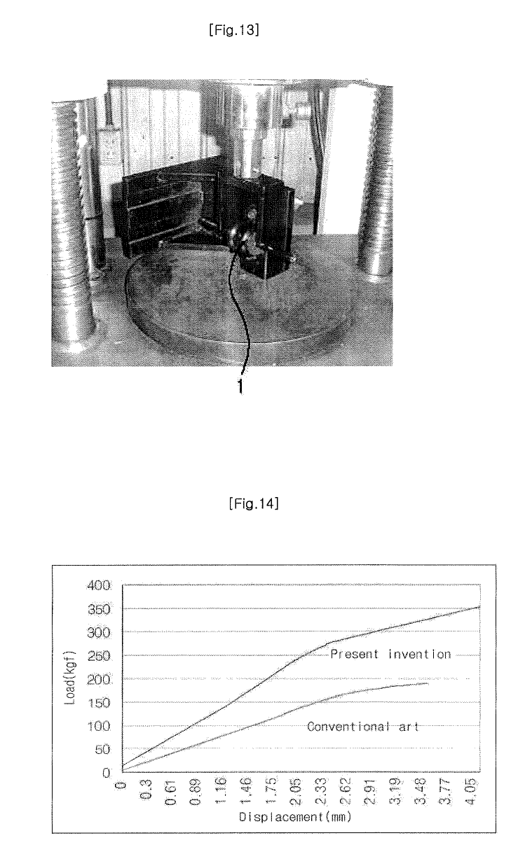

FIG. 13 is a picture showing a process of testing the stiffness of the mounting apparatus against a predetermined directional force. FIG. 14 is a graph showing the results of the test of FIG. 13. As shown in FIG. 13, the test, in which a load is applied to the stabilizer bar 2 in a predetermined direction at a speed of 10 mm/min, was conducted in a 20 ton class UTM using a separate jig that supported the mounting apparatus 1 such that the load could be applied to the stabilizer bar 2 in a predetermined direction. The results of the tests of the mounting apparatus of the present invention and the conventional mounting apparatus are compared in the graph of FIG. 14. As appreciated in the graph of FIG. 12, the mounting apparatus of the present invention required force greater than that of the conventional mounting apparatus to achieve the same displacement. Therefore, it is to be appreciated that the stiffness of the mounting apparatus of the present invention is greater than that of the conventional mounting apparatus.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides an apparatus for mounting a stabilizer bar for vehicles, which has improved ability to support the stabilizer bar, thus preventing the stabilizer bar from being pushed and leaning in one direction, and which reduces the stiffness of a rubber bushing with respect to the rotational direction, so that slippage between the stabilizer bar and the rubber bushing is prevented from being caused, thus preventing noise from being generated by friction, thereby keeping the vehicle interior quiet when the vehicle travels. Furthermore, because the rubber bushing is prevented from being worn by frictional heat, the durability of the rubber bushing can be enhanced. Moreover, the present invention enhances the internal stiffness of the rubber bushing, so that the rubber bushing is prevented from being deformed in the rotational direction of the stabilizer bar even after it is used for a long period. Therefore, a gap is prevented from occurring between the stabilizer bar and the rubber bushing, thus preventing foreign substances, which cause abrasion of the circumferential outer surface of the stabilizer bar, from entering between the stabilizer bar and the rubber bushing. Hence, the expected life span of the stabilizer bar can be markedly extended. As well, the rubber bushing is prevented from being deformed by compressing force when the rubber bushing is press-mounted to the vehicle body frame, thus enhancing the mounting force. Thanks to these advantages, the present invention is regarded as being very useful.

1. An apparatus for mounting a stabilizer bar to a vehicle body frame, comprising:
a rubber bushing, comprising: a main body having a holding hole formed at a central portion through opposite ends of the main body for insertion of the stabilizer bar into the holding hole, and a slit extending from an upper surface thereof to an upper surface of a sidewall of the holding hole such that the stabilizer bar is inserted into the holding hole; a plurality of elastic holes formed in each of the opposite ends of the main body to reduce stiffness of the main body in a rotational direction thereof, thus reducing rotational resistance of the stabilizer bar; and a stop protrusion provided on a circumferential outer surface of the main body;
a plurality of metal plates inserted into the main body of the rubber bushing to form a shape such that elastic holes are sectioned into first spaces and second spaces by the metal plates, thus preventing the rubber bushing from being deformed; and
a mounting bracket, comprising: a bushing receiving part having a stop groove engaging with the stop protrusion of the rubber bushing; and a pair of mounting plates provided on respective opposite edges of the bushing receiving part, the mounting bracket receiving the rubber bushing in a circumferential inner surface thereof and fastening the rubber bushing to the vehicle body frame.

2. The apparatus according to claim 1, wherein the holding hole of the rubber bushing has a diameter less than a diameter of the stabilizer bar, so that the rubber bushing is force-fitted over the stabilizer bar.

3. The apparatus according to claim 1, wherein the slit of the rubber bushing further extends from a lower surface of the sidewall of the holding hole to a predetermined depth.

4. The apparatus according to claim 1, wherein the plurality of elastic holes formed in each of the opposite ends of the main body of the rubber bushing are disposed at predetermined positions in a circular arrangement.

5. The apparatus according to claim 1, wherein each of the plurality of metal plates has a ‘C’ shape, so that the plurality of metal plates is inserted into the main body of the rubber bushing at positions that surround the holding hole in a cylindrical arrangement.
